(19) United States
(12) Patent Application Publication
(10) Pub. No.: US 2016/0189855 A1
(43) Pub. Date: Jun. 30, 2016

(54) Network transformer and producing method thereof

(71) Applicant: Mianyang Hi-Tech Zone Hongqiang Technology Co., Ltd., Mianyang (CN)

(72) Inventors: Daichun Yu, Mianyang (CN); Qiang Wang, Mianyang (CN)

(73) Assignee: Mianyang Hi-Tech Zone Hongqiang Technology Co., Ltd.

(21) Appl. No.: 14/585,206

(22) Filed: Dec. 30, 2014

(51) Int. Cl. H01F 27/30; H01F 41/06; H01F 27/24; H01F 27/29; H01F 21/00; H01F 27/28

(52) U.S. Cl. CPC H01F 27/30; H01F 21/00; H01F 27/2823; H01F 27/2895; H01F 27/24; H01F 27/29; H01F 41/0612

(57) ABSTRACT

A network transformer includes: a first magnetic ring; a first cable winded on the first magnetic ring, wherein the first cable comprises a first wire, a second wire, a third wire and a fourth wire; a second magnetic ring; and a second cable winded on the second magnetic ring, wherein the second cable comprises a fifth wire and a sixth wire; wherein a first end of the first wire is connected to a first end of the fifth wire, and a second end of the first wire is connected to a first end of the sixth wire. A producing method of the network transformer is also provided. With the above structure and producing method, automatic devices are applicable for producing the network transformer, which simplifies operation, improves production efficiency, and lowers labor costs.

### BACKGROUND OF THE PRESENT INVENTION

1. Field of Invention

The present invention relates to a network transformer, and more particularly to a network transformer with a plurality of coils.

2. Description of Related Arts

The conventional network transformer is produced by a conventional method. Referring to FIG. 11 of the drawings, the conventional network transformer is manually produced, wherein the coil A′ is winded before winding the coil B′ with wires branched from the coil A′. As a result, a production period is long, automatic devices are not applicable during production, and production efficiency is lowered.

### SUMMARY OF THE PRESENT INVENTION

An object of the present invention is to provide a network transformer for overcoming the above problems.

Accordingly, in order to accomplish the above object, the present invention provides a network transformer, comprising:

a first magnetic ring;

a first cable winded on the first magnetic ring, wherein the first cable comprises a first wire, a second wire, a third wire and a fourth wire;

a second magnetic ring; and

a second cable winded on the second magnetic ring, wherein the second cable comprises a fifth wire and a sixth wire;

wherein a first end of the first wire is connected to a first end of the fifth wire, and a second end of the first wire is connected to a first end of the sixth wire.

Accordingly, in order to accomplish the above object, the present invention also provides a producing method of a network transformer, comprising steps of:

a) winding a first cable on a first magnetic ring, wherein the first cable comprises a first wire, a second wire, a third wire and a fourth wire;

b) winding a second cable on a second magnetic ring, wherein the second cable comprises a fifth wire and a sixth wire; and

c) connecting a first end of the first wire to a first end of the fifth wire, and connecting a second end of the first wire to a first end of the sixth wire.

Different from a conventional network transformer, a coil A (formed by the first magnetic ring and the first cable) and a coil B (formed by the second magnetic ring and the second cable) according to the present invention are independently produced. Therefore, with the above structure and producing method, automatic devices are applicable for producing the network transformer, which simplifies operation, improves production efficiency, and lowers labor costs.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a first magnetic ring according to the present invention.

FIG. 2 is a sketch view of a second magnetic ring according to the present invention.

FIG. 3 is a sketch view of a network transformer according to a first preferred embodiment of the present invention.

FIG. 4 is a sketch view of the network transformer according to a second preferred embodiment of the present invention.

FIG. 5 is a sketch view of the network transformer in use according to the second preferred embodiment of the present invention.

FIG. 6 is a sketch view of the network transformer in use according to the second preferred embodiment of the present invention.

FIG. 7 is a sketch view of the network transformer according to a third preferred embodiment of the present invention.

FIG. 8 is a sketch view of a prior art. FIG. 9 is a sketch view of the prior art.

FIG. 10 is a sketch view of the prior art.

FIG. 11 is a sketch view of the prior art.

### DETAILED DESCRIPTION OF THE PREFERRED EMBODIMENT

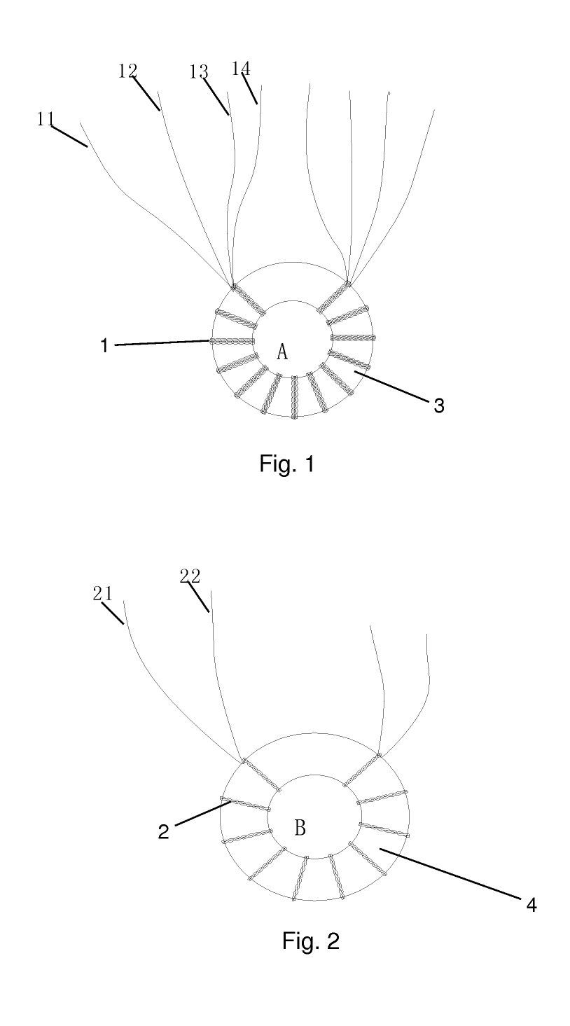

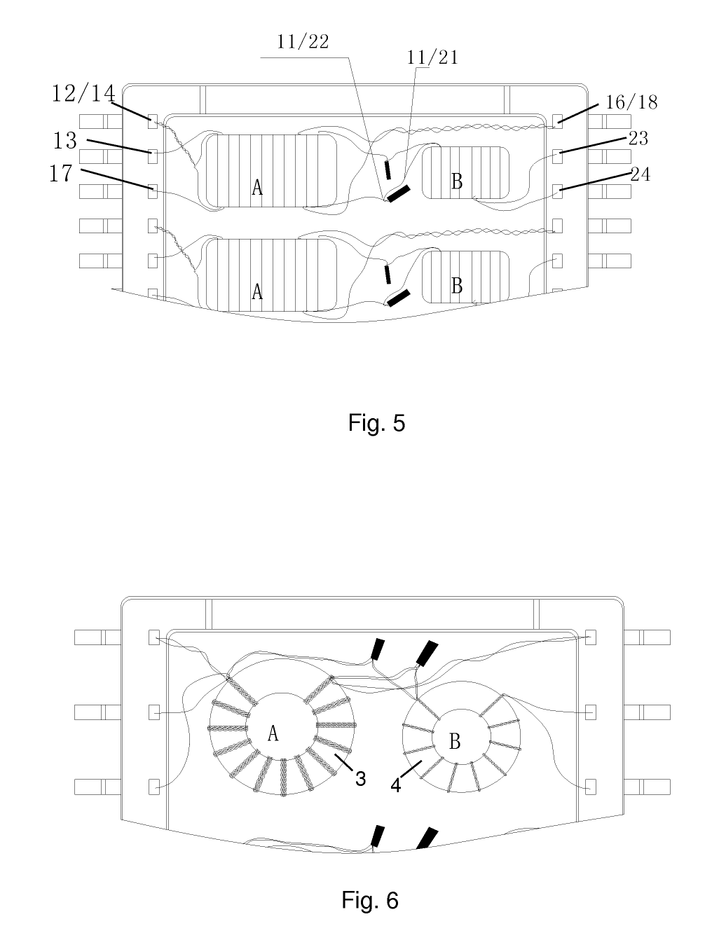

Referring to FIGS. 1-7 of the drawings, a network transformer according to preferred embodiments of the present invention is illustrated, comprising:

a first magnetic ring 3;

a first cable 1 winded on the first magnetic ring 3, wherein the first cable 1 comprises a first wire 11, a second wire 12, a third wire 13 and a fourth wire 14;

a second magnetic ring 4; and

a second cable 2 winded on the second magnetic ring 4, wherein the second cable 2 comprises a fifth wire 21 and a sixth wire 22;

wherein a first end of the first wire 11 is connected to a first end of the fifth wire 21, and a second end of the first wire 11 is connected to a first end of the sixth wire 22.

Preferably, the first magnetic ring 3 is made of a manganese-zinc alloy, and the second magnetic ring 4 is made of a nickel-zinc alloy.

Preferably, external diameters of the first magnetic ring 3 and the second magnetic ring 4 are 2.54˜mm, internal diameters of the first magnetic ring 3 and the second magnetic ring 4 are no less than 1.27 mm, and heights of the first magnetic ring 3 and the second magnetic ring 4 are no less than 0.76 mm.

Preferably, diameters of the first cable 1 and the second cable 2 are 0.07˜0.12 mm.

Preferably, the first cable 1 is wrapped around the first magnetic ring 3 10˜18 times for winding the first magnetic ring 3; and the second cable 2 is wrapped around the second magnetic ring 4 9˜15 times for winding the second magnetic ring 4.

Preferably, the first wire 11, the second wire 12, the third wire 13 and the fourth wire 14 are twisted together for forming the first cable 1; and the fifth wire 21 and the sixth wire 22 are twisted together for forming the second cable 2.

Preferably, the first wire 11, the second wire 12, the third wire 13 and the fourth wire 14 are clockwise twisted together with 6˜8 node/cm; and the fifth wire 21 and the sixth wire 22 are clockwise twisted together with 3˜5 node/cm.

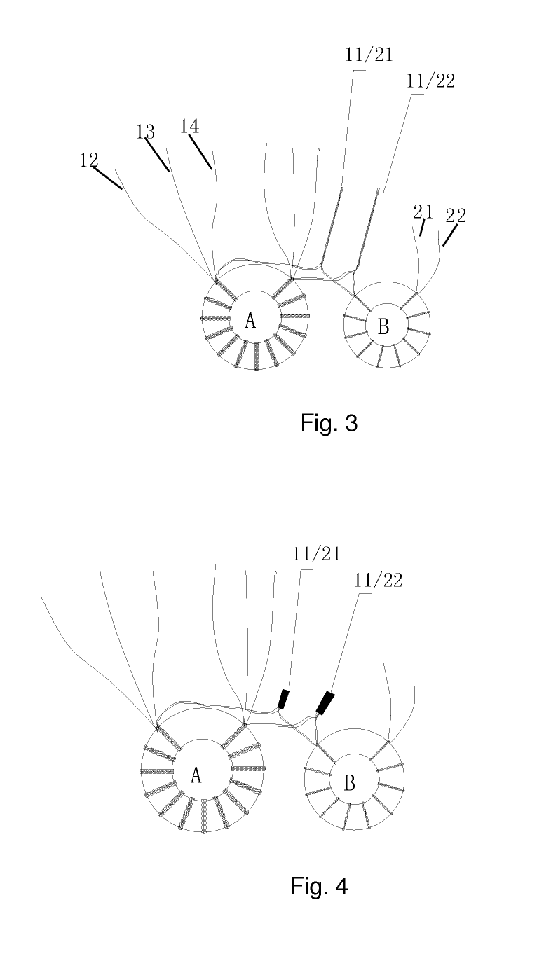

Referring to FIG. 3, a first preferred embodiment is illustrated, wherein the first end of the first wire 11 and the first end of the fifth wire 21 are twisted together, and the second end of the first wire 11 and the first end of the sixth wire 22 are twisted together.

Referring to FIGS. 4-6, a second preferred embodiment is illustrated, wherein the first end of the first wire 11 and the first end of the fifth wire 21 are welded together, and the second end of the first wire 11 and the first end of the sixth wire 22 are welded together.

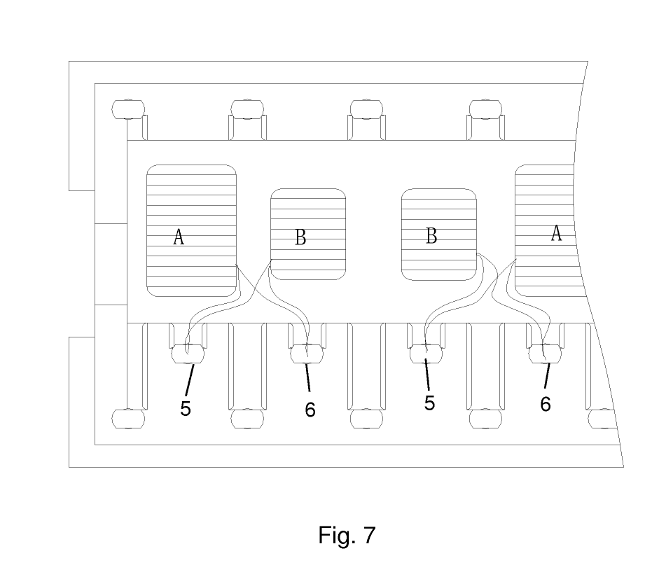

Referring to FIG. 7, a third preferred embodiment is illustrated, wherein the first end of the first wire 11 and the first end of the fifth wire 21 are connected to a first wiring terminal 5, and the second end of the first wire 11 and the first end of the sixth wire 22 are connected to a second wiring terminal 6.

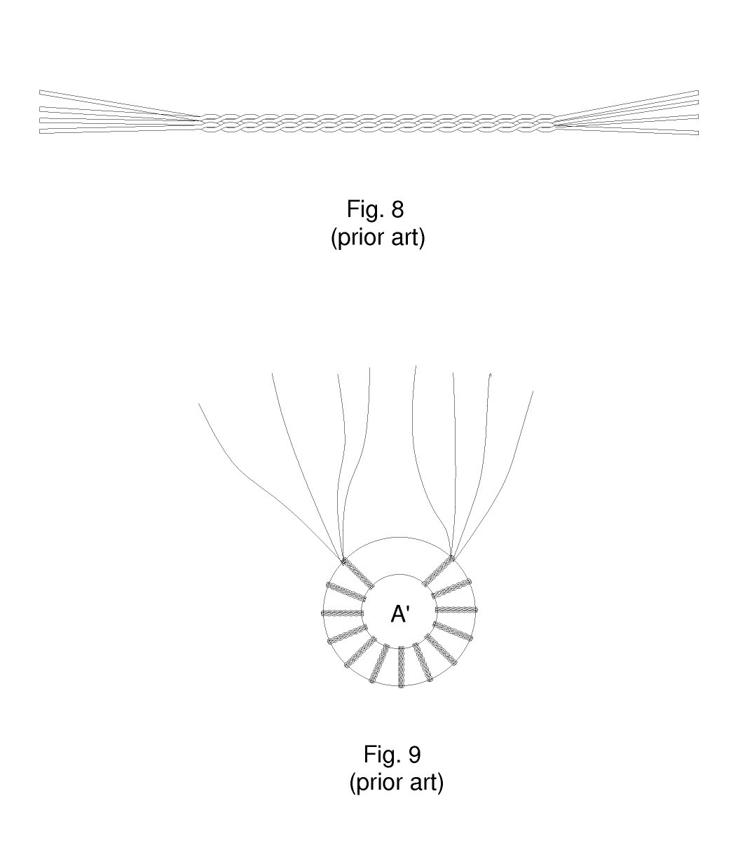

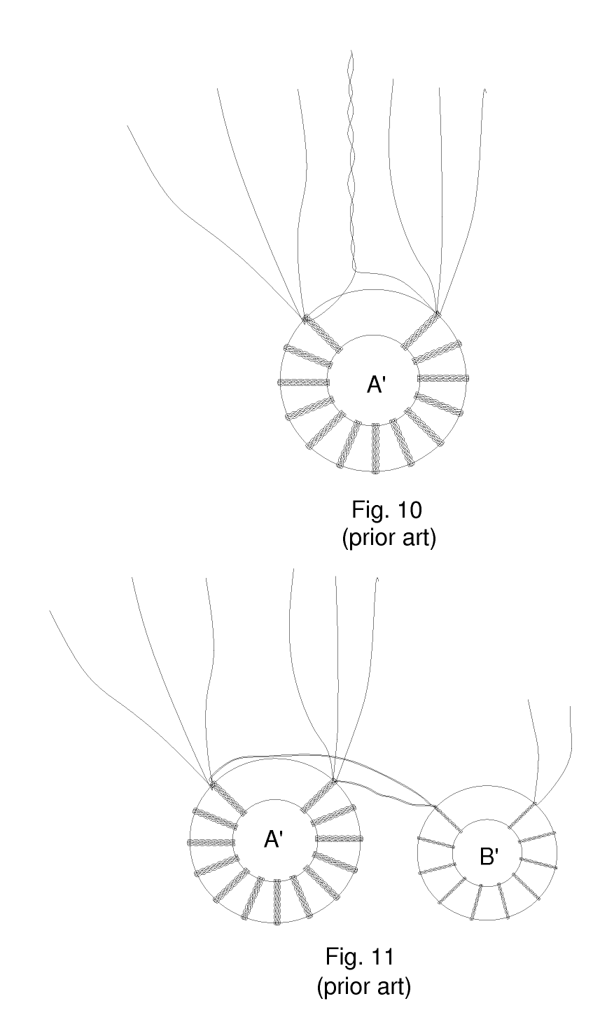

Referring to FIGS. 8-11, a conventional network transformer according to a prior art is manually produced, wherein a coil A′ is winded before winding the coil B′ with wires branched from the coil A′, wherein 60 seconds are needed for winding a coil A′ and 40 seconds are needed for winding a coil B′. As a result, a production period is long, automatic devices are not applicable during production, and production efficiency is lowered.

However, different from the conventional network transformer, a coil A (formed by the first magnetic ring 3 and the first cable 1) and a coil B (formed by the second magnetic ring 4 and the second cable 2) according to the present invention are independently produced. Therefore, with the above structure and producing method, automatic devices are applicable for producing the network transformer. As a result, only 6˜8 seconds are needed for winding the coil A and 4˜6 seconds are needed for winding the coil B, which simplifies operation, improves production efficiency, and lowers labor costs.

A producing method of a network transformer is also illustrated, comprising steps of:

a) winding a first cable 1 on a first magnetic ring 3, wherein the first cable 1 comprises a first wire 11, a second wire 12, a third wire 13 and a fourth wire 14;

b) winding a second cable 2 on a second magnetic ring 4, wherein the second cable 2 comprises a fifth wire 21 and a sixth wire 22; and

c) connecting a first end of the first wire 11 to a first end of the fifth wire 21, and connecting a second end of the first wire 11 to a first end of the sixth wire 22.

Preferably, the first magnetic ring 3 is made of a manganese-zinc alloy, and the second magnetic ring 4 is made of a nickel-zinc alloy.

Preferably, external diameters of the first magnetic ring 3 and the second magnetic ring 4 are 2.54˜6 mm, internal diameters of the first magnetic ring 3 and the second magnetic ring 4 are no less than 1.27 mm, and heights of the first magnetic ring 3 and the second magnetic ring 4 are no less than 0.76 mm.

Preferably, diameters of the first cable 1 and the second cable 2 are 0.07˜0.12 mm.

Preferably, the step a) specifically comprises a step of: wrapping the first cable 1 around the first magnetic ring 3 10˜18 times for winding the first magnetic ring 3; and the step b) specially comprises a step of: wrapping the second cable 2 around the second magnetic ring 4 9˜15 times for winding the second magnetic ring 4.

Preferably, the step a) further comprises a step of: twisting the first wire 11, the second wire 12, the third wire 13 and the fourth wire 14 together before winding; and the step b) further comprises a step of: twisting the fifth wire 21 and the sixth wire 22 are twisted together before winding.

Preferably, the first wire 11, the second wire 12, the third wire 13 and the fourth wire 14 are clockwise twisted together with 6˜8 node/cm; and the fifth wire 21 and the sixth wire 22 are clockwise twisted together with 3˜5 node/cm.

Preferably, the step c) specifically comprises steps of: twisting the first end of the first wire 11 and the first end of the fifth wire 21 together, and twisting the second end of the first wire 11 and the first end of the sixth wire 22 together.

Preferably, the step c) specifically comprises steps of: welding the first end of the first wire 11 and the first end of the fifth wire 21 together, and welding the second end of the first wire 11 and the first end of the sixth wire 22 together.

Preferably, the step c) specifically comprises steps of: connecting the first end of the first wire 11 and the first end of the fifth wire 21 to a first wiring terminal 5, and connecting the second end of the first wire 11 and the first end of the sixth wire 22 to a second wiring terminal 6.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A network transformer, comprising:
a first magnetic ring;
a first cable winded on said first magnetic ring, wherein said first cable comprises a first wire, a second wire, a third wire and a fourth wire;
a second magnetic ring; and
a second cable winded on said second magnetic ring, wherein said second cable comprises a fifth wire and a sixth wire;
wherein a first end of said first wire is connected to a first end of said fifth wire, and a second end of said first wire is connected to a first end of said sixth wire.

2. The network transformer, as recited in claim 1, wherein said first magnetic ring is made of a manganese-zinc alloy, and said second magnetic ring is made of a nickel-zinc alloy.

3. The network transformer, as recited in claim 1, wherein external diameters of said first magnetic ring and said second magnetic ring are 2.54˜6 mm, internal diameters of said first magnetic ring and said second magnetic ring are no less than 1.27 mm, and heights of said first magnetic ring and said second magnetic ring are no less than 0.76 mm.

4. The network transformer, as recited in claim 1, wherein diameters of said first cable and said second cable are 0.07˜0.12 mm.

5. The network transformer, as recited in claim 1, wherein said first cable is wrapped around said first magnetic ring 10˜18 times for winding said first magnetic ring;
and said second cable is wrapped around said second magnetic ring 9˜15 times for winding said second magnetic ring.

6. The network transformer, as recited in claim 1, wherein said first wire, said second wire, said third wire and said fourth wire are twisted together for forming said first cable; and said fifth wire and said sixth wire are twisted together for forming said second cable.

7. The network transformer, as recited in claim 6, wherein said first wire, said second wire, said third wire and said fourth wire are clockwise twisted together with 6˜8 node/cm; and said fifth wire and said sixth wire are clockwise twisted together with 3˜5 node/cm.

8. The network transformer, as recited in claim 1, wherein said first end of said first wire and said first end of said fifth wire are twisted together, and said second end of said first wire and said first end of said sixth wire are twisted together.

9. The network transformer, as recited in claim 1, wherein said first end of said first wire and said first end of said fifth wire are welded together, and said second end of said first wire and said first end of said sixth wire are welded together.

10. The network transformer, as recited in claim 1, wherein said first end of said first wire and said first end of said fifth wire are connected to a first wiring terminal, and said second end of said first wire and said first end of said sixth wire are connected to a second wiring terminal.

11. A producing method of a network transformer, comprising steps of:
a) winding a first cable on a first magnetic ring, wherein the first cable comprises a first wire, a second wire, a third wire and a fourth wire;
b) winding a second cable on a second magnetic ring, wherein the second cable comprises a fifth wire and a sixth wire; and
c) connecting a first end of the first wire to a first end of the fifth wire, and connecting a second end of the first wire to a first end of the sixth wire.

12. The producing method, as recited in claim 11, wherein the first magnetic ring is made of a manganese-zinc alloy, and the second magnetic ring is made of a nickel-zinc alloy.

13. The producing method, as recited in claim 11, wherein external diameters of the first magnetic ring and the second magnetic ring are 2.54˜6 mm, internal diameters of the first magnetic ring and the second magnetic ring are no less than 1.27 mm, and heights of the first magnetic ring and the second magnetic ring are no less than 0.76 mm.

14. The producing method, as recited in claim 11, wherein diameters of the first cable and the second cable are 0.07˜0.12 mm.

15. The producing method, as recited in claim 11, wherein the step a) specifically comprises a step of: wrapping the first cable around the first magnetic ring 10˜18 times for winding the first magnetic ring; and the step b) specially comprises a step of:
wrapping the second cable around the second magnetic ring 9˜15 times for winding the second magnetic ring.

16. The producing method, as recited in claim 11, wherein the step a) further comprises a step of: twisting the first wire, the second wire, the third wire and the fourth wire together before winding; and the step b) further comprises a step of: twisting the fifth wire and the sixth wire are twisted together before winding.

17. The producing method, as recited in claim 16, wherein the first wire, the second wire, the third wire and the fourth wire are clockwise twisted together with 6˜8 node/cm;
and the fifth wire and the sixth wire are clockwise twisted together with 3˜5 node/cm.

18. The producing method, as recited in claim 11, wherein the step c) specifically comprises steps of: twisting the first end of the first wire and the first end of the fifth wire together, and twisting the second end of the first wire and the first end of the sixth wire together.

19. The producing method, as recited in claim 11, wherein the step c) specifically comprises steps of: welding the first end of the first wire and the first end of the fifth wire together, and welding the second end of the first wire and the first end of the sixth wire together.

20. The producing method, as recited in claim 11, wherein the step c) specifically comprises steps of: connecting the first end of the first wire and the first end of the fifth wire to a first wiring terminal, and connecting the second end of the first wire and the first end of the sixth wire to a second wiring terminal.
